(19) United States
(12) Patent Application Publication
(10) Pub. No.: US 2004/0018932 A1
(43) Pub. Date: Jan. 29, 2004

(54) Composition for producing a porcelain enamel having a metallic appearance

(76) Inventors: Boris Yuriditsky, Baltimore, MD (US); Vincent Duchamp, Lambersart (FR)

Correspondence Address: VENABLE, BAETJER, HOWARD AND CIVILETTI, LLP, P.O. BOX 34385, WASHINGTON, DC, 20043-9998, US

(21) Appl. No.: 10/608,124

(22) Filed: Jun. 30, 2003

Related U.S. Application Data
(60) Provisional application No. 60/391,924, filed on Jun. 28, 2002.

(51) Int. Cl. C03C 8/02; C03C 8/06

(52) U.S. Cl. 501/21; 501/25

(57) ABSTRACT

A composition for producing a porcelain enamel having a metallic appearance includes a first mixture which forms a polyoxide surface crystal having a metallic appearance when the composition is heated to a temperature ranging from 700 to 1,000° C. and which is composed of from about 0.7 to about 2 wt. % of NiO; from about 2.5 to about 8 wt. % of MnO₂; and from about 5 to about 11 wt. % of TiO₂; and remainder a second mixture which is a porcelain enamel forming mixture. Advantageously, the composition additionally includes at least one of from about 0.2 to about 0.8 wt. % of CuO, from about 0.05 to about 0.3 wt. % of CoO, and/or from about 0.2 to about 0.6 wt. % of Fe₂O₃.

### BACKGROUND OF THE INVENTION

1. Field of the Invention.

This invention relates to a novel composition for producing a porcelain enamel having a metallic appearance when coated onto suitable substrates such as metals and ceramics. In particular, this invention relates a composition for producing a porcelain enamel having a metallic appearance, to a glass frit useful for producing a porcelain enamel having a metallic appearance; to an article coated with the glass frit and fired to provide a porcelain enamel having a metallic appearance, use of the composition to produce a porcelain enamel coating having a metallic appearance, and to a method for producing a porcelain enamel coating having a metallic appearance.

2. Description of the related art.

Compositions for producing porcelain enamels are well known in the art, see, for example, U.S. Pat. No. 4,361,654 to Ohmura et al., the disclosure of which is incorporated herein by reference. Ohmura et al. disclose a broad range of porcelain enamel frit compositions for sheet iron ground coat which are said to have excellent firing properties and to produce sheet iron enamel having high gloss and adherence, and low surface roughness. The compositions of Ohmura et al. contain no fluorine or fluorine compounds which had been conventionally used as fluxes to promote smelting by lowering the smelting temperature of compositions for producing frits, but which are toxic. Ohmura et al. address the problem of obtaining good properties without inclusion of fluorine and solve the problem by inclusion of MoO₃, Na₂O and the like as essential constituents in the frit composition. A broad range of oxide constituents are disclosed and the frit compositions may contain oxides such as TiO₂, NiO, and MnO₂.

Published European Application No. 1,256,556 A1 to Eckmann et al. discloses a porcelain enamel composition for use in forming opaque porcelain enamel coatings having good acid resistence on a metal substrate. While inclusion of opacifiers in prior art compositions tended to produce adhesion problems and/or poor acid resistance, the compositions of Eckmann et al. are said to readily adhere to metal substrates, such as steel, that are degreased only. A broad range of oxide constituents are disclosed and the frit compositions may contain oxides such as TiO₂ (2-11 wt %), NiO (0-2%), and MnO₂ (0-2.9%).

Compositions for producing porcelain enamels are conventionally produced by weighing and mixing enamel-forming oxides to provide a mixture and smelting the mixture in a furnace at a smelting temperature effective to melt even the higher melting point oxides, i.e., above the crystallization temperature, e.g., from about 1,000 to about 1,250° C., and produce a glassy product which is then rapidly cooled (quenched) and crushed into a glass flit. Smelting at temperatures above crystallization produces a melt which is oversaturated so that the quenched frit has substantially no crystals in the amorphous matrix. The frit is comminuted to a particle sized based on the intended application and applied to a substrate as a powder layer or as a slip. The layer is then fired, or dried and fired if a slip, at a firing temperature effective to melt the glass frit, e.g., about 700 to about 1,000° C., and provide a coating known as a porcelain enamel. Firing at a firing temperature ranging from about 700 to about 1,000° C. is low enough to promote crystallization in compositions including opacifiers, such as titanium oxide and/or cerium oxide, for producing opacified porcelain enamels.

The substrate may be a metal, such as low carbon steel, for an article whose intended use requires a porcelain enamel coating, such a cookware or appliances including stoves, washers and dryers. The substrate may be a clay or a ceramic for an article whose intended use requires a porcelain enamel coating, such as pottery or tile.

The porcelain enamel is generally pigmented to provide a pleasing color, for example, appliance white or cookware red. For certain articles, such as pottery or tile, the porcelain enamel may be applied in a pattern to provide a pleasing design.

When a metallic appearance, i.e., a surface having an appearance which is lustrous, i.e., reflecting light evenly, like a typical metal, is desired one conventional technique applies a coating containing a noble metal, such as gold or platinum, onto an existing porcelain enamel coating and fires the coating at relatively high temperatures on the order of about 1500° C. This method is disadvantageous as being costly in terms of materials and time in terms of requiring an extra processing step.

Other, less expensive conventional techniques are known. These include spraying the hot surface of an existing porcelain enamel coating with a ferric chloride solution to obtain a metallic appearance or including salts of metals in the milled composition to obtain a glossy appearance which imitates a metallic appearance. Manganese salts, for example, incorporated into a milled frit composition crystallize during firing of the frit powder layer to provide a porcelain enamel layer having a crystalline MnO₂ surface layer having a glossy dark reddish brown appearance which imitates a copper brown color but is distinguishable as having a glossy appearance rather than a lustrous metallic appearance.

There are, however, no glassy frits for porcelain enamels in the prior art which produce a porcelain enamel having a metallic appearance which is aesthetically pleasing, i.e., an appearance which is lustrous, i.e., reflecting light evenly, like a typical metal in contrast to simply glossy.

Accordingly, it is an object of the present invention to provide a composition for producing a glass frit which can be fired to provide a porcelain enamel having a metallic appearance.

It is another object of the invention to provide a glass flit which can be fired to provide a porcelain enamel having a metallic appearance.

It is yet another object of the present invention to provide an article coated with the glass frit and fired to provide a porcelain enamel having a metallic appearance.

It is a further object of the present invention to provide a method of using the composition to produce a porcelain enamel coating having a metallic appearance.

It is a still further object of the present invention to provide a method for producing a porcelain enamel coating having a metallic appearance.

### SUMMARY OF THE INVENTION

These and other objects are achieved by providing a composition for producing a porcelain enamel having a metallic appearance including a first mixture which forms a polyoxide surface crystal having a metallic appearance when the composition is heated to a temperature ranging from about 700 to about 1,000° C. and which is comprised of from about 0.7 to about 2 wt. % of NiO; from about 2.5 to about 8 wt. % of MnO₂; and from about 5 to about 11 wt. % of TiO₂; and remainder a second mixture which is a glass forming mixture.

The composition may advantageously further comprise at least one of from about 0.2 to about 0.8 wt. % of CuO; from about 0.05 to about 0.3 wt. % of CoO; and from about 0.2 to about 0.6 wt. % of Fe₂O₃ Thus, the composition may advantageously further comprise from about 0.2 to about 0.8 wt. % of CuO. The composition may additionally or alternatively further comprise from about 0.05 to about 0.3 wt. % of CoO, and from about 0.2 to about 0.6 wt. % of Fe₂O₃.

In a preferred embodiment of the composition, the first mixture comprises about 1 wt. % of nickel oxide (NiO); about 6 wt. % of manganese oxide (MnO₂); and about 9 wt. % of titania benelite (TiO₂); the first mixture further comprises about 0.5 wt. % of copper oxide (CuO); about 0.3 wt. % of cobalt oxide (CoO); and about 0.3 wt. % of iron oxide (Fe₂O₃); and the second mixture comprises about 40.9 wt. % of silica (SiO₂); about 19 wt. % of borax (Na₂B₂0₇); about 3 wt. % of potassium nitrate (KNO3); about 6 wt. % of potassium carbonate (K₂CO₃); about 12 wt. % of potassium silicofluoride; and about 2 wt. % of sodium tripolyphosphate.

These and other objects are achieved by additionally providing a glass frit comprising any of the compositions described above, such as a composition for producing a porcelain enamel having a metallic appearance including a first mixture which forms a polyoxide surface crystal having a metallic appearance when the composition is heated to a temperature ranging from about 700 to about 1,000° C. and which is comprised of from about 0.7 to about 2 wt. % of NiO; from about 2.5 to about 8 wt. % of MnO₂; and from about 5 to about 11 wt. % of TiO₂; and remainder a second mixture which is a glass forming mixture.

The composition of the glass frit may advantageously further comprise at least one of from about 0.2 to about 0.8 wt. % of CuO; from about 0.05 to about 0.3 wt. % of CoO; and from about 0.2 to about 0.6 wt. % of Fe₂O₃. Thus, the composition of the glass frit may advantageously further comprise from about 0.2 to about 0.8 wt. % of CuO. The composition of the glass frit may additionally or alternatively further comprise from about 0.05 to about 0.3 wt. % of CoO, and from about 0.2 to about 0.6 wt. % of Fe₂O₃.

These and other objects are achieved by providing an article coated with a porcelain enamel having a metallic appearance, comprising a substrate which may be fired at a temperature effective to melt the compositions described above; a porcelain enamel coating which is provided on the substrate, which is comprised of any of the compositions described above, which has a thickness ranging from about 10 to about 300 μm, and which has a metallic appearance.

These and other objects are achieved by providing a method for providing a porcelain enamel coating having a metallic appearance on a substrate, comprising providing any of the compositions described above; coating the composition on the substrate to provide a coating precursor layer; and firing the coating precursor layer at a temperature effective to produce the porcelain enamel coating having a metallic appearance.

These and other objects are achieved by providing a method for producing a porcelain enamel coating having a metallic appearance, comprising providing any of the compositions described above; preparing a glass frit from the composition by smelting the composition at a temperature effective to melt the composition and provide a melt; allowing the melt to cool to a glass followed by fracturing to provide the glass frit; grinding the glass frit into a powder; applying the powder onto a substrate to provide a coating precursor layer; firing the coating precursor layer at a temperature ranging from about 700 to about 1,000° C. to provide a porcelain enamel coating; and allowing the porcelain enamel coating to cool to room temperature. Smelting the composition is not limited to but may advantageously take place at a temperature ranging from 1,000 to 1,250° C. The substrate may be one of a metal, a ceramic, or a glass. The substrate may be a steel, such as stainless steel.

### DETAILED DESCRIPTION OF THE INVENTION

When a glass frit coating precursor layer according to the invention is fired to provide a porcelain enamel coating, the firing temperature ranges from about 700 to about 1,000° C. This firing temperature range is low enough to promote crystallization of the NiO and at least one of TiO₂ and MnO₂ to form a polyoxide crystalline surface layer but high enough for this process to be completed in a practical firing period.

The inventors determined that an otherwise conventional porcelain enamel composition could be modified to contain three oxides, namely, NiO, MnO₂, and TiO₂, in particular weight ranges, to produce glass frits which, when fired, produce a porcelain enamel having an aesthetically pleasing metallic appearance. The metallic appearance has colors or tints which range from gunmetal to dark stainless steel or bronze or brass.

While the cause of the advantageous metallic appearance is not fully understood, the inventors consider that the metallic appearance is due to surface crystallization of a polyoxide crystalline phase. This phase appears to be composed of a polyoxide crystal including NiO, TiO₂ and MnO₂, such as a polyoxide crystal having a general formula (TiO₂)ₓ(MnO₂)_{y}(NiO)_{z}, where no more than one of x, y, and z can be zero. This polyoxide may be similar to, for example, nickel magnetite. The inventors have proven the presence of such a polyoxide crystal using X-ray diffraction analysis, however, the precise ranges of values of x, y, and z are not yet known.

In view of the foregoing, the concentrations of the oxides NiO, TiO₂ and MnO₂ have been described in this disclosure. The lower weight limits for these oxides were selected as being the minimum concentration considered to provide the crystallization of the polyoxide crystalline surface phase associated with the desired metallic appearance. The upper weight limits for these oxides were selected based on preventing crystallization of unwanted single crystals of the individual oxides. For example, when the MnO₂ concentration in the composition is higher than about 8 wt. %, brown colored single oxide crystals of MnO₂ are noted on the surface in addition to the sought after polyoxide crystalline phase having the metallic appearance. Such MnO₂ crystallization produces an undesirable brown tint to the surface.

The presence of the NiO appears to be the primary contributor to obtaining a metallic appearance. Compositions with less NiO have a less metallic appearance. High NiO content, however, is accompanied by a greenish color and an uneven surface believed to be due to excessive crystallization. If a greenish color is not desired, the tint can be adjusted toward bronze or brass by increasing the amount of MnO₂ and/or CoO. Greater amounts of MnO₂ produce a bronze color. Greater amounts of CoO produce a gunmetal color.

In addition to CoO, the inventors determined that the appearance of the porcelain enamel coatings could be influenced by the presence of an additional oxide, Fe₂O₃. The CoO and the Fe₂O₃ do not appear to contribute to the metallic appearance per se, but CoO advantageously permits controlling the tint by reducing the greenish color of high NiO compositions as mentioned above, while Fe₂O₃ appears to help maintain, i.e., stabilize, the crystallinity of the phase with the metallic appearance.

The TiO₂ does not appear to contribute to the color of the polyoxide crystalline surface layer per se but may be incorporated as a member of the crystal lattice structure. When the concentration of TiO₂ ranges from about 5 to about 11 wt. %, an aesthetically pleasing metallic appearance and color are obtained in combination with the NiO and MnO₂. When the concentration of the TiO₂ is above this range, desired crystallization is inhibited. When the concentration of the TiO₂ is below this range, crystallization of single crystals of, for example, MnO₂, were noted and have an undesirable color.

While optional, the presence of CuO has been found to stabilize the color, possibly by a redox mechanism which maintains the crystallinity of the phase with the metallic appearance. Without the presence of CuO, the phase with the metallic appearance was noted to be somewhat transparent.

The metallic appearance of porcelain enamels according to the invention can thus be varied by adjusting three parameters: concentrations of the foregoing oxide materials (degree of metallic appearance, depth of color, and transparency), relative ratios of the foregoing oxide materials with respect to one another (color, tint), and thickness (lightness versus darkness).

Studies show that the polyoxide surface crystalline phase present on the surface of the porcelain enamel has a thickness of about 10 micron. The remainder of the thickness of the porcelain enamel coating, i.e., the volume, was observed to be transparent in this sample. Whether the volume of the porcelain enamel coating, as opposed to the polyoxide surface crystalline phase, is transparent or not, the metallic appearance of the polyoxide surface crystalline phase is substantially the same. Notably, therefore, the polyoxide surface crystalline phase which produces the metallic appearance of porcelain enamels according to the present invention does not necessarily cause opacification of the volume of the porcelain enamel unlike frit compositions according to the prior art discussed herein which may contain oxides such as TiO₂, NiO, and MnO₂.

The inventors consider that the advantageous surface crystallization according to the present invention may be caused by or contributed to by surface oxidation due to the presence of oxygen in ambient air. The presence of ambient oxygen might additionally serve to keep the polyoxide surface crystalline phase in the oxidation state(s) that produce the aesthetically appealing metallic appearance.

Compositions are prepared by conventional techniques including combining and blending materials to provide a substantially uniform mixture, smelting the mixture at a temperature effective to melt the constituents of the mixture, for example, at a temperature ranging from about 750 to about 1,250° C., preferably about 1,000 to about 1,250° C. to provide a melt; and rapidly cooling, i.e., quenching, the melt to provide a glass frit.

The parts to be enameled according to the invention may be coated by conventional techniques, powder spray coating (electrostatic) being preferred. For electrostatic application to a substrate, the glass frits are milled to a powder having a fineness of about 20% on a 325 mesh, although the fineness may be adjusted over a very broad range to suit the intended application. An encapsulating agent, such as a conventional organosilicate, is added in an amount of about 0.2 wt. %, but this amount may be varied over a broader range along the lines of the conventional range for this type of agent. The encapsulating agent coats at least partially the particles of the powder and provides electrostatic properties to the powder. Such agents are in wide spread use and their exact chemical nature is typically proprietary. The powder is then sprayed onto the substrate by conventional equipment for electrostatic application to a desired thickness, for example, a thickness ranging from about 10 μm to about 300 μm, preferably a thickness ranging from of about 50 μm to about 200 μm, particularly about 100 μm, to provide a coated substrate. The coated substrate is then fired at a firing temperature effective to promote formation of surface crystallization, for example, at a temperature ranging from about 700 to about 1,000° C., preferably from about 750 to about 800° C.

When the substrate is a steel, the substrate is provided with a conventional ground coat, i.e., a conventional black enamel having a high metal content so that its adherence to the steel substrate is enhanced.

### WORKING EXAMPLE

A composition was prepared by combining the following materials in weight percent (wt. %) as follows:

an oxide mixture according to the invention:

about 1 wt. % of nickel oxide (NiO);

about 6 wt. % of manganese oxide (MnO₂); and

about 9 wt. % of titania benelite (TiO₂);

optional oxides according to the invention:

about 0.5 wt. % of copper oxide (CuO);

about 0.3 wt. % of cobalt oxide (CoO); and

about 0.3 wt. % of iron oxide (Fe₂O₃); and

porcelain enamel forming oxides:

about 40.9 wt. % of silica (SiO₂);

about 19 wt. % of borax (Na₂B₂O₇);

about 3 wt. % of potassium nitrate (KNO₃);

about 6 wt. % of potassium carbonate (K₂CO₃);

about 12 wt. % of potassium silicofluoride; and

about 2 wt. % of sodium tripolyphosphate.

The mixture was blended to provide a substantially uniform mixture, smelted at 1,200° C. to provide a melt; and rapidly cooled, i.e., quenched, to provide a glassy frit. The glassy frit was analyzed and found to contain an oxide composition as follows in weight percent.

| | |
|---|---|
| 1.2% | NiO; |
| 4.9% | MnO₂; |
| 9.5% | TiO₂; |
| 0.5% | CuO; |
| 0.2% | CoO; |
| 0.8% | Fe₂O₃; |
| 6.8% | Na₂O; |
| 0.4% | Al₂O₃; |
| 46.9% | SiO₂; |
| 11.1% | K₂O; |
| 13.6% | B₂O₃; |
| 3.1% | F; and |
| 1.0% | P₂O₅. |

The resulting porcelain enamel had a metallic appearance which was determined to be due to the presence of a polyoxide surface crystal including NiO and at least one of TiO₂ and MnO₂. The tint of the resulting porcelain enamel coating was found to be influenced by the presence of two oxides, namely, CoO and Fe₂O₃, but these oxides did not contribute to the metallic effect per se. The CuO was considered to stabilize the color of the porcelain enamel. The remaining oxides constitute a conventional porcelain enamel.

The glassy frit was milled to a powder having a fineness of 20% on a 325 mesh with the addition of 0.2 wt. % of an organosilicate encapsulating agent which provides electrostatic properties to the powder. The powder was then sprayed onto the substrate by conventional equipment for electrostatic application to a thickness of 100 μm to provide a coated substrate. The coated substrate was then fired at a temperature of about 800° C. and allowed to cool. A uniform porcelain enamel coating was obtained having an aesthetically pleasing metallic appearance similar to that of steel. The enamel coating was found to have a polyoxide surface crystalline phase which provided the metallic appearance with the bulk of the coating being relatively transparent.

It is understood that various other modifications will be apparent to and can be readily made by those skilled in the art without departing from the scope and spirit of the present invention. Accordingly, it is not intended that the scope of the claims appended hereto be limited to the description set forth above but rather that the claims be construed as encompassing all of the features of patentable novelty which reside in the present invention, including all features which would be treated as equivalents thereof by those skilled in the art to which the invention pertains.

What is claimed is:

1. A composition for producing a porcelain enamel having a metallic appearance, comprising:
a first mixture which forms a polyoxide surface crystal having a metallic appearance when the composition is heated to a temperature ranging from about 700 to about 1,000° C. and which is comprised of:
from about 0.7 to about 2 wt. % of NiO;
from about 2.5 to about 8 wt. % of MnO₂; and
from about 5 to about 11 wt. % of TiO₂; and
remainder a second mixture which is a porcelain enamel forming mixture.

2. The composition according to claim 1, further comprising at least one of:
from about 0.2 to about 0.8 wt. % of CuO;
from about 0.05 to about 0.3 wt. % of CoO; and
from about 0.2 to about 0.6 wt. % of Fe₂O₃.

3. The composition according to claim 1, further comprising:
from about 0.2 to about 0.8 wt. % of CuO.

4. The composition according to claim 1, further comprising:
from about 0.05 to about 0.3 wt. % of CoO, and from about 0.2 to about 0.6 wt. % of Fe₂O₃.

5. The composition according to claim 1,
wherein the first mixture comprises:
about 1 wt. % of nickel oxide (NiO);
about 6 wt. % of manganese oxide (MnO₂); and
about 9 wt. % of titania benelite (TiO₂);
wherein the first mixture further comprises:
about 0.5 wt. % of copper oxide (CuO);
about 0.3 wt. % of cobalt oxide (CoO); and
about 0.3 wt. % of iron oxide (Fe₂O₃); and
wherein the second mixture comprises:
about 40.9 wt. % of silica (SiO₂);
about 19 wt. % of borax (Na₂B₂0₇);
about 3 wt. % of potassium nitrate (KNO3);
about 6 wt. % of potassium carbonate (K₂CO₃);
about 12 wt. % of potassium silicofluoride; and
about 2 wt. % of sodium tripolyphosphate.

6. A glass frit, comprising the composition of claim 1 and having
from about 5 to about 11 wt. % of TiO₂;
from about 2.5 to about 8 wt. % of MnO₂; and
from about 0.7 to about 2 wt. % of NiO.

7. The glass frit according to claim 6, further comprising at least one of:
from about 0.2 to about 0.8 wt. % of CuO;
from about 0.05 to about 0.3 wt. % of CoO; and
from about 0.2 to about 0.6 wt. % of Fe₂O₃.

8. The glass frit according to claim 6, further comprising:
from about 0.2 to about 0.8 wt. % of CuO.

9. The glass frit according to claim 6, further comprising:
from about 0.05 to about 0.3 wt. % of CoO, and
from about 0.2 to about 0.6 wt. % of Fe₂O₃.

10. An article coated with a porcelain enamel having a metallic appearance, comprising:
a substrate which may be fired at a temperature effective to melt the composition according to claim 1;
a porcelain enamel coating which is provided on the substrate, which is comprised of the composition according to claim 1, which has a thickness ranging from about 10 to about 300 μm, and which has a metallic appearance.

11 A method for providing a porcelain enamel coating having a metallic appearance on a substrate, comprising:
providing a composition according to claim 1;
coating the composition on the substrate to provide a coating precursor layer; and
firing the coating precursor layer at a temperature effective to produce the porcelain enamel coating having a metallic appearance.

12. A method for producing a porcelain enamel coating having a metallic appearance, comprising:
providing a composition according to claim 1;
preparing a glass frit from the composition by smelting the composition at a temperature effective to melt the composition and provide a melt;
allowing the melt to cool to a glass followed by fracturing to provide the glass frit;
grinding the glass frit into a powder;
applying the powder onto a substrate to provide a coating precursor layer;
firing the coating precursor layer at a temperature ranging from about 700 to about 1,000° C. to provide a porcelain enamel coating; and
allowing the porcelain enamel coating to cool to room temperature.

13. The method according to claim 12, wherein smelting the composition takes place at a temperature ranging from 1,000 to 1,250° C.

14. The method according to claim 12, wherein the substrate is one of a metal, a ceramic, or a glass.

15. The method according to claim 14, wherein the substrate is steel.
